(19) United States
(12) Patent Application Publication
(10) Pub. No.: US 2020/0143964 A1
(43) Pub. Date: May 7, 2020

(54) CYLINDRICAL COMPOSITE PERMANENT MAGNET AND MAGNETIC ASSEMBLY COMPRISING THE SAME

(71) Applicant: GANZHOU POLY-MAX MAGNETICS CO., LTD., Jiangxi (CN)

(72) Inventors: Jiahong MENG, Tianjin (CN); Shuai ZHAO, Hebei (CN); Buchang SHI, Shandong (CN); Wenbao CAO, Anhui (CN); Kevin WANG, Zhejiang (CN)

(73) Assignee: GANZHOU POLY-MAX MAGNETICS CO., LTD., Jiangxi (CN)

(21) Appl. No.: 16/671,329

(22) Filed: Nov. 1, 2019

(30) Foreign Application Priority Data
Nov. 2, 2018 (CN) 201811300241.2

(51) Int. Cl. H01F 1/057; H01F 41/02; H01F 7/02; H02K 15/03; H02K 1/30; H02K 1/27

(52) U.S. Cl. CPC H01F 1/0577; H01F 41/0293; H01F 7/0278; H02K 1/2733; H02K 15/03; H01F 7/0294; H02K 1/30; H01F 7/0221

(57) ABSTRACT

Embodiment of the present invention provides a cylindrical composite permanent magnet and a magnetic assembly including the same, wherein the cylindrical composite permanent magnet comprises at least one annular permanent magnet having a first magnetic parameter value and at least one annular permanent magnet having a second magnetic parameter value, wherein the at least one annular permanent magnet having the first magnetic parameter value and at least one annular permanent magnet having the second magnetic parameter value are jointed to form the cylindrical composite permanent magnet. The cylindrical composite permanent magnet in the invention is obtained by jointing at least one annular permanent magnet having the first magnetic parameter value and at least one annular permanent magnet having the second magnetic parameter value; the magnetic property of the cylindrical composite permanent magnet can be adjusted by selecting the material type and length of the joint annular permanent magnet.

### TECHNICAL FIELD

The present invention relates to the field of permanent magnet materials, and in particular to a cylindrical composite permanent magnet and a magnetic assembly comprising the same.

### BACKGROUND OF THE INVENTION

Magnetic materials are basic functional materials of the electronics industry. As an important part of magnetic materials, permanent magnet materials play an important role in the electronics industry, information industry, motorcycles, power tools industry, automotive industry and other industries. The permanent magnet materials are functional materials that generate a magnetic field. The permanent magnet materials used in traditional DC motors, whether sintered or moulded, are made of one-piece materials. When the size of the motor is determined, the geometry of the corresponding permanent magnet material is determined. In this way, the magnetic properties of the permanent magnet material can only be adjusted by the change of the material itself (type of material and grade of the same material). For example, sintered NdFeB N35SH, N42SH; ferrite; bonded NdFeB BNM-10 (corresponding to MQ magnetic powder B powder), BNM-8SR (corresponding to MQ magnetic powder 14-12), AlNiCo or Samarium Cobalt, and the like are used. In fact, different types of magnetic materials have significant differences in magnetic properties, including maximum magnetic energy product (BH, max), remanence (Br), intrinsic coercive force (Hcj), coercive force (Hcb), etc. For example, the magnetic characteristics of the most common ferrite, bonded NdFeB and sintered NdFeB are as follows.

TABLE 1
Characteristics of the commercially
available and mainly used magnets

| | Magnetic properties | | |
|---|---|---|---|
| | | | Maximum |
| | | | magnetic energy |
| | | | product |
| | Remanence, | Coercive force, | (BH), max, |
| Materials | Br(T) | Hcj(kA/m) | kJ/m³ |
| Ferrite | 0.3-0.44 | 250-350 | 25-36 |
| Bonded NdFeB | 0.6-0.78 | 500-1300 | 28-96 |
| Sintered NdFeB | 1.1-1.4 | 800-2400 | 240-420 |

As can be seen from Table 1, the value range of magnetic energy product for bonded NdFeB is substantially connecting to that for ferrite. However, there is a significant gap between the performances of sintered NdFeB and bonded NdFeB. For example, the maximum magnetic energy product of bonded NdFeB is 28-96 kJ/m³, while the maximum magnetic energy product of sintered NdFeB is 240-420 kJ/m³. There is a gap of more than 100 kJ/m³ in terms of maximum magnetic energy product between the materials. Therefore, these materials are relatively limited when used in magnetic circuit design and practical application of motors.

### SUMMARY OF THE INVENTION

The object of examples of the present invention is to provide a cylindrical composite permanent magnet and a magnetic assembly comprising the same.

The specific technical solutions are as follows.

First, the present invention provides a cylindrical composite permanent magnet, comprising at least one annular permanent magnet having a first magnetic parameter value and at least one annular permanent magnet having a second magnetic parameter value, wherein the at least one annular permanent magnet having a first magnetic parameter value and at least one annular permanent magnet having a second magnetic parameter value are joint to form the cylindrical composite permanent magnet.

In some specific embodiments of the present invention, the annular permanent magnet is integrally formed or is formed by jointing a plurality of permanent magnets having the same magnetic parameter value along the circumferential direction of the annular permanent magnet; preferably, the material of the plurality of permanent magnets having the same magnetic parameter value are the same; more preferably, the plurality of permanent magnets having the same magnetic parameter value have a tile-like shape.

In some specific embodiments of the present invention, the material of the at least one annular permanent magnet having the first magnetic parameter value and of the at least one annular permanent magnet having the second magnetic parameter value are the same or different.

In some specific embodiments of the present invention, the material of the annular permanent magnet is one or more selected from the group consisting of anisotropic sintered ferrite, anisotropic bonded ferrite, isotropic sintered ferrite, isotropic bonded ferrite, sintered NdFeB, anisotropic sintered NdFeB, anisotropic bonded NdFeB, isotropic bonded NdFeB, AlNiCo, bonded samarium cobalt, sintered samarium cobalt and samarium iron nitrogen permanent magnet material.

In some specific embodiments of the present invention, wherein each annular permanent magnet is fixed to each other by an adhesive; preferably, the adhesive is an anaerobic adhesive; more preferably, the adhesive is a polyurethane-based adhesive, a bi-component modified acrylate curing agent or an epoxy-based adhesive.

In some specific embodiments of the present invention, before each annular permanent magnet is fixed to each other by the adhesive, the surface of each annular permanent magnet is subjected to an activating treatment, including:

(1) subjecting each annular permanent magnet to an anti-corrosion treatment, preferably electrophoresis, respectively;

(2) immersing each annular permanent magnet subjected to the anti-corrosion treatment in an adhesion promoter to perform surface activating treatment; and

(3) applying an adhesive uniformly to a portion to be bonded on each annular permanent magnet, correcting a position, bonding together, and then performing a curing treatment.

In some specific embodiments of the present invention, the at least one annular permanent magnet having first magnetic parameter value and the at least one annular permanent magnet having the second magnetic parameter value are jointed with an interval of odd annular permanent magnets, when the number of the annular permanent magnets having the first magnetic parameter value is M, the number of the annular permanent magnet having the second magnetic parameter value is N and M=N±1 (M≥1, N≥1).

The at least one annular permanent magnet having the first magnetic parameter value and the at least one annular permanent magnet having the second magnetic parameter value are jointed with an interval of even annular permanent magnets, when the number of the annular permanent magnets having the first magnetic parameter value is M, the number of the annular permanent magnet having the second magnetic parameter value is N, and M=N or M=N±2 (M and N are even number equal to or greater than 2).

In some specific embodiments of the present invention, the cylindrical composite permanent magnet is coated with a non-magnetic metal sleeve on its surface; preferably, the non-magnetic metal sleeve is a non-magnetic stainless steel sleeve; more preferably, the non-magnetic metal sleeve has a thickness of 0.01 mm-5 mm.

The present invention also provides a magnetic assembly for a motor, comprising the aforementioned cylindrical composite permanent magnet, a motor shaft core and a housing.

In some specific embodiments of the present invention, the cylindrical composite permanent magnet is configured to fix to a motor shaft core by bonding a shaft in an inner hole or position fixing via injection molding, or fix to the housing by bonding the housing on an outer wall or position fixing via injection molding.

A cylindrical composite permanent magnet is obtained in the present invention by jointing at least one annular permanent magnet having a first magnetic parameter value and at least one annular permanent magnet having a second magnetic parameter value. The magnetic property of the cylindrical composite permanent magnet can be adjusted by selecting the material type and length of the jointed annular permanent magnet, so that a permanent magnet motor designer and user have a more diversified and flexible selection for material and cost.

### DESCRIPTION OF THE DRAWINGS

In order to illustrate the technical solutions in the examples of the present invention or in the prior art more clearly, the drawings used in the examples or the prior art description will be briefly described below. It is obvious that the drawings in the following description are only some examples of the present invention, and those skilled in the art can obtain other drawings according to these drawings without any creative work.

FIG. 1A is a schematic view showing the structure of a cylindrical composite permanent magnet provided by the present invention;

FIG. 1B is a schematic view showing the structure of an annular permanent magnet used to form a cylindrical composite permanent magnet;

FIG. 2 is a schematic view showing the structure of an annular permanent magnet formed by jointing a plurality of permanent magnets having the same magnetic parameter value;

FIG. 3 is a schematic view showing the structure of a tile-like shape permanent magnet.

### DETAILED DESCRIPTION OF THE INVENTION

First, the invention provides a cylindrical composite permanent magnet, comprising at least one annular permanent magnet having a first magnetic parameter value and at least one annular permanent magnet having a second magnetic parameter value, wherein the at least one annular permanent magnet having the first magnetic parameter value and at least one annular permanent magnet having the second magnetic parameter value are jointed to form the cylindrical composite permanent magnet.

In the present invention, the term of “magnetic parameter” has a meaning well known in the art, and it is an indicator characterizing the magnetic property of the permanent magnet, including but not limited to maximum magnetic energy product (BH, max), remanence (Br), intrinsic coercive force (Hcj), coercive force (Hcb), magnetic field strength (such as surface magnetic field strength), magnetic flux and the like.

In the present invention, the first magnetic parameter value and the second magnetic parameter value are used to represent different values corresponding to the same magnetic parameter.

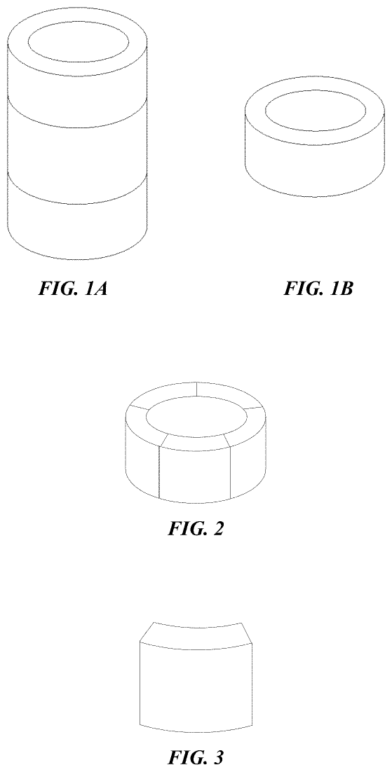

In the present invention, the cylindrical permanent magnet refers to a permanent magnet having a larger height value and annular top and bottom surface (as shown in FIG. 1A).

In the present invention, the annular permanent magnet refers to a permanent magnet having a smaller height value and annular top and bottom surface (as shown in FIG. 1B). Each annular permanent magnet forming the cylindrical composite permanent magnet has top and bottom surface with identical shape and size, and has identical or different height. The expression of “annular” can be a shape of “ring” or “ring-like”. The expression of “ring-like” can be understood as an annulus with a special-shape structure; for example, an annulus having a circular outer profile and an inner hole with a non-slip platform or a non-slip rib, an annulus having a circular outer profile and an inner hole having a regular octagon or a regular dodecagon, or the like.

In the present invention, jointing means that the annular permanent magnets are jointed along the height direction of the cylindrical composite permanent magnet.

In some specific embodiments of the present invention, the annular permanent magnet may be integrally formed, for example, the annular permanent magnet can be obtained by a single molding process of compressing, injection, extrusion, and the like. Alternatively, the annular permanent magnet can be formed by jointing a plurality of permanent magnets having the same magnetic parameter value along the circumferential direction of the annular permanent magnet. For example, the annular permanent magnet shown in FIG. 2 is formed by jointing five permanent magnets having the same magnetic parameter value along the circumferential direction of the annular permanent magnet. In a specific embodiment, a plurality of permanent magnets having the same magnetic parameter value can be jointed and fixed by an adhesive to form an annular permanent magnet.

In some specific embodiments of the present invention, the materials of the plurality of permanent magnets having the same magnetic parameter value are the same.

In some specific embodiments of the present invention, the plurality of permanent magnets having the same magnetic parameter value have a tile-like shape (as shown in FIG. 3). Of course, it is also possible to joint a plurality of permanent magnets with the same shape and magnetic parameter value to obtain an annular permanent magnet.

In some specific embodiments of the present invention, the materials of the at least one annular permanent magnet having the first magnetic parameter value and the at least one annular permanent magnet having the second magnetic parameter value are the same or different.

In some specific embodiments of the present invention, the materials of the annular permanent magnet may be one or more selected from the group consisting of anisotropic sintered ferrite, anisotropic bonded ferrite, isotropic sintered ferrite, isotropic bonded ferrite, anisotropic sintered NdFeB, anisotropic bonded NdFeB, isotropic bonded NdFeB, AlNiCo, bonded samarium cobalt, sintered samarium cobalt and samarium iron nitrogen permanent magnet material.

More specifically, among the annular permanent magnets having the first or second magnetic parameter value, the one with a greater magnetic property may be made of one or more materials selected from the group consisting of anisotropic sintered ferrite, anisotropic bonded ferrite, anisotropic sintered NdFeB, anisotropic bonded NdFeB, bonded samarium cobalt, sintered samarium cobalt or other bonded magnets made by compressing, injection, or extrusion, etc.

Among the annular permanent magnets having the first or second magnetic parameter value, the one with a lower magnetic property may be made of one or more materials selected from the group consisting of isotropic sintered ferrite, anisotropic sintered ferrite, isotropic bonded ferrite, anisotropic bonded ferrite, AlNiCo, sintered NdFeB, isotropic bonded NdFeB, anisotropic bonded NdFeB, sintered samarium cobalt, bonded samarium cobalt, samarium iron nitrogen or other bonded magnets made by compressing, injection, or extrusion, etc.

In some specific embodiments of the present invention, each annular permanent magnet can be jointed and fixed by an adhesive to form a cylindrical composite permanent magnet. In some specific embodiments of the present invention, the adhesive is an anaerobic adhesive; more specifically, the adhesive is a polyurethane-based adhesive, a bi-component modified acrylate curing agent or an epoxy-based adhesive.

In some specific embodiments of the present invention, before each annular permanent magnet is fixed to each other by an adhesive, the surface of each annular permanent magnet is subjected to an activating treatment, including:

(1) subjecting each annular permanent magnet to an anti-corrosion treatment, respectively;

(2) immersing each annular permanent magnet subjected to the anti-corrosion treatment in an adhesion promoter to perform surface activating treatment; and

(3) applying an adhesive uniformly to a portion to be bonded on each annular permanent magnet, correcting a position, bonding together, and then performing a curing treatment.

In some specific embodiments of the present invention, the anti-corrosion treatment can be specifically electrophoresis. Certainly, those skilled in the art can also use other anti-corrosion treatment, such as electroplating metal plating (such as nickel, or zinc, etc.), air spraying anti-corrosion layer, Parylene process and the like.

In some specific embodiments of the invention, in addition to fixing to each other by an adhesive, each annular permanent magnets forming the cylindrical composite permanent magnets can be configured to fix to a motor shaft core by bonding a shaft in an inner hole or position fixing via injection molding, or fixed to the housing by bonding the housing on the outer wall or position fixing via injection molding, so as to joint into a cylindrical composite permanent magnet, and to obtain a motor magnetic assembly. The fixing manners such as bonding the shaft in the inner hole are those can be realized by those skilled in the art, which will not be described in details herein.

In some specific embodiments of the present invention, the at least one annular permanent magnet having the first magnetic parameter value and the at least one annular permanent magnet having the second magnetic parameter value are jointed with an interval of odd annular permanent magnets, when the number of the annular permanent magnets having the first magnetic parameter value is M, the number of the annular permanent magnet having the second magnetic parameter value is N and M=N±1 (M≥1, N≥1).

For example, when the number of annular permanent magnets having the first magnetic parameter value is M=1, the number of annular permanent magnets having the second magnetic parameter value is N=2, and the magnetic property of the annular permanent magnet having the first magnetic parameter value (hereinafter referred to as a greater magnetic ring) is greater than that of the annular permanent magnet having the second magnetic parameter value (hereinafter referred to as a lower magnetic ring), the annular permanent magnets are jointed with an odd interval in a manner of lower magnetic ring+greater magnetic ring+lower magnetic ring. When the number of annular permanent magnets having the first magnetic parameter value (greater magnetic rings) is M=2 and the number of annular permanent magnets having the second magnetic parameter value (lower magnetic rings) is N=3, the annular permanent magnets are jointed with an odd interval in a manner of lower magnetic ring+greater magnetic ring+lower magnetic ring+greater magnetic ring+lower magnetic ring.

In some specific embodiments of the present invention, the at least one annular permanent magnet having the first magnetic parameter value and at least one annular permanent magnet having the second magnetic parameter value are jointed with an interval of even annular permanent magnets, when the number of annular permanent magnets having the first magnetic parameter value is M, the number of annular permanent magnets having the second magnetic parameter value is N, and M=N or M=N±2 (M, N are even number equal to or greater than 2).

For example, when the number of annular permanent magnets having the first magnetic parameter value is M=4, the number of annular permanent magnets having the second magnetic parameter value is N=2, the annular permanent magnet having the first magnetic parameter value is a greater magnetic ring and the annular permanent magnet having the second magnetic parameter value is a lower magnetic ring, the annular permanent magnets are jointed with an even interval in a manner of greater magnetic ring+greater magnetic ring+lower magnetic ring+lower magnetic ring+greater magnetic ring+greater magnetic ring. When the number of annular permanent magnets having the first magnetic parameter value (greater magnetic rings) is M=2 and the number of annular permanent magnets having the second magnetic parameter value (lower magnetic rings) is N=4, the annular permanent magnets are jointed with an even interval in a manner of lower magnetic ring+lower magnetic ring+greater magnetic ring+greater magnetic ring+lower magnetic ring+lower magnetic ring.

In some specific embodiments of the present invention, the cylindrical composite permanent magnet can be coated with a non-magnetic metal sleeve on its surface.

In some specific embodiments of the present invention, the non-magnetic metal sleeve can be a non-magnetic stainless steel sleeve. In some specific embodiments of the present invention, the non-magnetic metal sleeve has a thickness of 0.01 mm-5 mm.

In the present invention, the surface of the cylindrical composite permanent magnet may be understood as the entire or part of the outer surface of the composite permanent magnet. For example, it may be an outer wall surface; or comprises at least one of a top surface and a bottom surface, and an outer wall surface; or at least one of a top surface and a bottom surface, and an inner wall surface.

After coating with the non-magnetic metal sleeve, when the cylindrical composite permanent magnet is used in the motor, the non-magnetic metal sleeve in the motor does not affect the performance of the magnet or the magnetic circuit of the motor, and can effectively prevent the damage of high centrifugal force and heat generated by high-speed rotation of the cylindrical composite permanent magnet to the structure when the motor is running at a high speed.

The present invention also provides a magnetic assembly for a motor comprising the aforementioned cylindrical composite permanent magnet, a motor shaft core and a housing.

In some specific embodiments of the present invention, the cylindrical composite permanent magnet is configured to fix to a motor shaft core by bonding a shaft in an inner hole or position fixing via injection molding, or fix to the housing by bonding the housing on the outer wall or position fixing via injection molding.

The technical solutions of the present invention are clearly and completely described below through specific examples. It is obvious that the described examples are only a part of the examples of the present invention, not all of the examples. All other examples obtained by those skilled in the art based on the examples of the present invention without creative efforts are within the scope of the present invention.

The cylindrical composite in the following examples is obtained by bonding each annular permanent magnet with an anaerobic adhesive (such as Loctite cylindrical retaining adhesive series 6 and Loctite structural adhesive series 3) as an adhesive, and the surfaces of the annular permanent magnets are activated prior to bonding:

(1) subjecting each annular permanent magnet to an electrophoresis, respectively;

(2) immersing each annular permanent magnet after electrophoresis in an anaerobic adhesive accelerator (such as Loctite 7649) for surface activation of the magnet;

(3) uniformly coating the anaerobic adhesive on the portions to be bonded on the annular permanent magnets, bonding them together after correcting the position, after 10 minutes, wiping excess adhesive off from bonding site on the magnet with rags dipped in industrial alcohol or acetone, and curing at 120° C. for 10 minutes after 1 hour.

Characterization of permanent magnets of motor: surface magnetic field strength and magnetic flux are two very important parameters. When different magnets are jointed, two main parameters are surface magnetic field strength and magnetic flux on the shaft after the produce is magnetized. The tests of surface magnetic field strength and magnetic flux are performed by using conventional methods in the art. For example, the surface magnetic field strength can be measured by a Gauss meter, and the magnetic flux can be tested by a Helmholtz coil connected with a fluxmeter.

### Example 1

A permanent magnet product having top and bottom surfaces with an outer diameter of 12.5 mm, an inner diameter of 6 mm, and a height of 12.5 mm was prepared by the following method:

(1) Only a bonded NdFeB BNM-10 was used to obtain a non-jointed product (corresponding to MQ magnetic powder B powder) by a single molding, which was magnetized on the outer surface by 2 poles in the radial direction and mounted on the shaft, the measured surface magnetic field strength was 1950 GS-2020 GS, and the magnetic flux was 4.12 mWb-4.22 mWb;

(2) Only a bonded NdFeB BNM-12 was used to obtain a non-jointed product (corresponding to MQ magnetic powder B+ powder) by a single molding, which was magnetized on the outer surface by 8 poles in the radial direction and mounted on the shaft, the measured surface magnetic field strength was 2100 GS-2150 GS, and the magnetic flux was 4.43 mWb-4.54 mWb;

(3) Only a sintered NdFeB N35UH was used to obtain a non jointed product by a single molding, which was magnetized on the outer surface by 2 poles in the radial direction and mounted on the shaft, the measured surface magnetic field strength was 5300 GS-5500 GS, and the magnetic flux was 11.18 mWb-11.58 mWb.

(4) A bonded NdFeB BNM-10 annular permanent magnet with height H=3.25 mm+a sintered NdFeB N35UH annular permanent magnet with height H=6 mm+a bonded NdFeB BNM-10 annular permanent magnets with height H=3.25 mm were jointed to form a cylindrical composite permanent magnet, which was magnetized on the outer surface by 2 poles in the radial direction and mounted on the shaft, the measured surface magnetic field strength of the bonded NdFeB magnets at both ends was 1930 GS-1990 GS, the magnetic field strength of high-performance annular surface in the middle was 5400 GS-5500 GS, and the magnetic flux was 7.65 mWb-7.82 mWb.

(5) A bonded NdFeB BNM-12 annular permanent magnet with height H=3.25 mm+a sintered NdFeB N35UH annular permanent magnet with height H=6 mm+a bonded NdFeB BNM-12 annular permanent magnets with height H=3.25 mm were jointed to form a cylindrical composite permanent magnet, which was magnetized on the outer surface by 2 poles in the radial direction and mounted on the shaft, the measured surface magnetic field strength of the bonded NdFeB magnets at both ends was 2090 GS-2150 GS, the magnetic field strength of high-performance annular surface in the middle was 5300 GS-5490 GS, and the magnetic flux was 7.69 mWb-7.90 mWb.

It can be seen by comparing the permanent magnet products obtained by the above methods (1) to (5), the cylindrical composite permanent magnet obtained by jointing bonded NdFeB magnets and sintered NdFeB magnets with different properties, when used as a permanent magnet of a motor, the magnetic flux thereof can transits from the characteristics of bonded NdFeB to sintered NdFeB, which makes the designer and user of the permanent magnet motor have a more diversified and flexible selection for material and cost.

Further, the outer side wall of the cylindrical composite permanent magnet obtained by the methods (4) and (5) was coated with a tubular non-magnetic stainless steel or other tubular non-magnetic material having a thickness of 0.05 mm to 5 mm, and a height of 0.5 mm to 10 mm greater than that of the permanent magnet. The corners of the top and bottom surfaces of the magnets were covered by rolling or any other means. The tubular non-magnetic stainless steel or other tubular non-magnetic material for coating was closely attached to the outer side wall and the corner of the cylindrical composite permanent magnet, which makes the whole jointed magnetic ring structure more stable and suitable for high-speed motor.

### Example 2

A permanent magnet product having an outer diameter of 25 mm, an inner diameter of 21 mm, and a height of 60 mm was prepared.

It is known to those skilled in the art that it is very difficult to obtain a monoblock bonded NdFeB product of H=60 mm. It can be obtained by the following methods:

(1) A permanent magnet formed by jointing two H=30 mm bonded NdFeB BNM-10 annular permanent magnets was magnetized on the outer surface by 8 poles in the radial direction and mounted on the shaft, the measured surface magnetic field strength was 1720 GS-1760 GS, and the magnetic flux was 2.12 mWb-2.14 mWb;

(2) A permanent magnet formed by jointing three H=20 mm bonded NdFeB BNM-10 annular permanent magnets was magnetized on the outer surface by 8 poles in the radial direction and mounted on the shaft, the measured surface magnetic field strength was 1750 GS-1800 GS, and the magnetic flux was 2.15 mWb-2.17 mWb;

(3) A permanent magnet formed by jointing two H=30 mm bonded NdFeB BNM-12 annular permanent magnets was magnetized on the outer surface by 8 poles in the radial direction and mounted on the shaft, the measured surface magnetic field strength was 2060 GS-2120 GS, and the magnetic flux was 2.41 mWb-2.42 mWb;

(4) A permanent magnet formed by jointing three H=20 mm bonded NdFeB BNM-12 annular permanent magnets was magnetized on the outer surface by 8 poles in the radial direction and mounted on the shaft, the measured surface magnetic field strength was 2100 GS-2150 GS, and the magnetic flux was 2.47 mWb-2.48 mWb;

(5) A bonded NdFeB BNM-12 annular permanent magnet with height H=20 mm+a sintered NdFeB N35SH annular permanent magnet with height H=20 mm+a bonded NdFeB BNM-12 annular permanent magnets with height H=20 mm were jointed to form a cylindrical composite permanent magnet; the product was magnetized on the outer surface by 8 poles in the radial direction and mounted on the shaft, the measured surface magnetic field strength of the bonded NdFeB magnets at both ends was 2090 GS-2140 GS, the magnetic field strength of sintered NdFeB surface in the middle was 3300 GS-3340 GS, and the magnetic flux was 3.07 mWb-3.09 mWb.

The cylindrical bonded NdFeB magnet prepared in (1)-(4) in the present example was prepared by a conventional vertical compression molding method in the art. The product has a high density at both ends and a low density in the middle since it is compressed in two directions. It also has a high product height, and a low total product density.

In addition, the density of bonded NdFeB magnets with H=20 mm is higher than that of bonded NdFeB magnets with H=30 mm. The H=60 composite permanent magnetic material formed by jointing three H=20 mm bonded NdFeB has an overall density higher than that of formed by jointing two H=30 mm bonded NdFeB. Therefore, the weight of the three-piece bonded product is 2-3% higher than that of the two-piece bonded product. Since the magnetic properties of the bonded NdFeB isotropic product are basically positively correlated with weight, the magnetic flux of the product after magnetization increases by 2-3%.

In example 2, the magnetic flux of the cylindrical composite permanent magnet prepared according to the method (5) is about 24% higher than that of the composite permanent magnet prepared by three bonded NdFeB BNM-12 annular permanent magnets according to the method (4); and about 27% higher than that of the composite permanent magnet prepared by two bonded NdFeB BNM-12 annular permanent magnets according to the method (3).

### Example 3

A permanent magnet product having a top surface and a bottom surface with an outer diameter of 51.1 mm, an inner diameter of 46.4 mm, and a height of 36.2 mm was prepared by the following method.

(1) A permanent magnet formed by jointing two H=18.1 mm bonded NdFeB BNM-12 annular permanent magnets was magnetized on inner surface by 36 poles in radial direction, the measured surface magnetic field strength was 3000 GS-3200 GS, and the magnetic flux was 6.0 mWb-6.37 mWb.

(2) A cylindrical composite permanent magnet was formed by jointing two H=9 mm bonded NdFeB BNM-12 annular permanent magnets and one H=18.2 mm annular magnet formed by jointing 9 pieces of tile-shape sintered NdFeB N35SH magnets, the outer surfaces of which were bonded to a magnetic conductive iron sleeve. The cylindrical composite permanent magnet had two bonded NdFeB annular permanent magnets with H=9 mm at both ends, and was magnetized on inner surface by 36 poles in radial direction. The measured surface magnetic field strength at both ends was 3100 GS-3250 GS, the magnetic field strength of inner surface of the middle annular magnets was 3950 GS-4100 GS, and the magnetic flux was 7.12 mWb-7.5 mWb.

In this example, the overall performance of bonded NdFeB+sintered NdFeB+bonded NdFeB is about 18% higher than that of bonded NdFeB alone, which greatly improves the utilization and overall performance of the magnet.

It should be noted that, in this application, relational terms such as “first” and “second” are only used to distinguish one substance or operation from another, and do not necessarily require or imply any actual relationship or order as such. Moreover, the term of “include”, “comprise” or any other variation is intended to encompass a non-exclusive inclusion, such that a process, method, article, or device comprising a plurality of elements includes not only those elements but also other elements not explicitly listed, or further includes elements inherent to such a process, method, article, or device. An element that is defined by the phrase “comprising a . . . ” does not exclude the presence of additional equivalent elements in the process, method, article, or device that comprises the element.

The various examples in the present specification are described in a related manner, and the same or similar parts of the various examples may be referred to each other, and each example focuses on the differences from the other examples. In particular, for the system example, since it is basically similar to the method example, the description is relatively simple, and the relevant parts can be referred to the description of the method example.

The above is only the preferred example of the present invention and is not intended to limit the scope of the present invention. Any modifications, equivalents, and improvements, etc. made within the spirit and scope of the invention are included within the scope of the invention.

1. A cylindrical composite permanent magnet, comprising at least one annular permanent magnet having a first magnetic parameter value and at least one annular permanent magnet having a second magnetic parameter value, wherein the at least one annular permanent magnet having the first magnetic parameter value and the at least one annular permanent magnet having the second magnetic parameter value are jointed to form the cylindrical composite permanent magnet.

2. The cylindrical composite permanent magnet according to claim 1, wherein the annular permanent magnet is integrally formed or is formed by jointing a plurality of permanent magnets having a same magnetic parameter value along a circumferential direction of the annular permanent magnet.

3. The cylindrical composite permanent magnet according to claim 1, wherein the materials of the at least one annular permanent magnet having the first magnetic parameter value and of the at least one annular permanent magnet having the second magnetic parameter value are the same or different.

4. The cylindrical composite permanent magnet according to claim 3, wherein the material of the annular permanent magnet is one or more selected from the group consisting of anisotropic sintered ferrite, anisotropic bonded ferrite, isotropic sintered ferrite, isotropic bonded ferrite, sintered NdFeB, anisotropic sintered NdFeB, anisotropic bonded NdFeB, isotropic bonded NdFeB, AlNiCo, bonded samarium cobalt, sintered samarium cobalt and samarium iron nitrogen permanent magnet material.

5. The cylindrical composite permanent magnet according to claim 1, wherein each annular permanent magnet is fixed to each other by an adhesive.

6. The cylindrical composite permanent magnet according to claim 5, wherein before each annular permanent magnet is fixed to each other by the adhesive, a surface of each annular permanent magnet is subjected to an activating process, including:
(1) subjecting each annular permanent magnet to an anti-corrosion treatment respectively;
(2) immersing each annular permanent magnet subjected to the anti-corrosion treatment in an adhesion promoter to perform surface activating treatment; and
(3) applying an adhesive uniformly to a portion to be bonded on each annular permanent magnet, correcting a position, bonding together, and then performing curing treatment.

7. The cylindrical composite permanent magnet according to claim 1, wherein the at least one annular permanent magnet having the first magnetic parameter value and the at least one annular permanent magnet having the second magnetic parameter value are jointed with an interval of odd annular permanent magnets, when the number of the annular permanent magnets having the first magnetic parameter value is M, the number of the annular permanent magnet having the second magnetic parameter value is N and M=N±1 (M≥1, N≥1); or
the at least one annular permanent magnet having the first magnetic parameter value and the at least one annular permanent magnet having the second magnetic parameter value are jointed with an interval of even annular permanent magnets, when the number of the annular permanent magnets having the first magnetic parameter value is M, the number of the annular permanent magnet having the second magnetic parameter value is N, and M=N or M=N±2 (M and N are even numbers equal to or greater than 2).

8. The cylindrical composite permanent magnet according to claim 1, wherein cylindrical composite permanent magnet is coated with a non-magnetic metal sleeve on its surface.

9. A magnetic assembly for a motor comprising the cylindrical composite permanent magnet according to claim 1, a motor shaft core and a housing.

10. The magnetic assembly for a motor according to claim 9, wherein the cylindrical composite permanent magnet is configured to fix to the motor shaft core by bonding a shaft in an inner hole or position fixing via injection molding, or fix to the housing by bonding the housing on the outer wall or position fixing via injection molding.

11. The cylindrical composite permanent magnet according to claim 2, wherein the materials of the plurality of permanent magnets having the same magnetic parameter value are the same.

12. The cylindrical composite permanent magnet according to claim 2, wherein the plurality of permanent magnets having the same magnetic parameter value have a tile-like shape.

13. The cylindrical composite permanent magnet according to claim 5, wherein the adhesive is an anaerobic adhesive.

14. The cylindrical composite permanent magnet according to claim 5, wherein the adhesive is a polyurethane-based adhesive, a bi-component modified acrylate curing agent or an epoxy-based adhesive.

15. The cylindrical composite permanent magnet according to claim 6, wherein in the step (1), each annular permanent magnet is subjected to an electrophoresis.

16. The cylindrical composite permanent magnet according to claim 8, wherein the non-magnetic metal sleeve is a non-magnetic stainless steel sleeve.

17. The cylindrical composite permanent magnet according to claim 8, wherein the non-magnetic metal sleeve has a thickness of 0.01 mm-5 mm.
